(19) United States
(12) Patent Application Publication
(10) Pub. No.: US 2003/0180137 A1
(43) Pub. Date: Sep. 25, 2003

(54) Device for gripping and transporting workpieces in turning machines

(76) Inventor: Helmut Schuster, Denklingen (DE)

Correspondence Address: Boris G Tankhilevich, Suite A, 536 North Civic Drive, Walnut Creek, CA, 94596, US

(21) Appl. No.: 10/296,309

(22) PCT Filed: May 23, 2001
(86) PCT No.: PCT/DE01/01967

(30) Foreign Application Priority Data
May 24, 2000 (DE) 100 25 614.7

(51) Int. Cl. B65G 47/24

(52) U.S. Cl. 414/746.3

(57) ABSTRACT

The invention relates to a transport and gripping device (10) for transporting workpieces (40) to and from a processing device (20). Said transport and gripping device comprises a gripping mechanism (50, 52) for gripping the workpiece (40); a device for moving the workpiece in the longitudinal direction thereof by displacement of said transport and gripping device; a device for turning the workpiece parallel to the direction of gripping; and a device for rotating the workpiece about the lateral axis thereof. Said transport and gripping device also comprises an arm (32, 32a), the gripper (38, 50, 52) being attached to the distal end thereof. Said device used to move the workpiece in a longitudinal direction (40) is embodied in such a way that the arm (32, 32a) is moved in a substantially transversal manner across the longitudinal side thereof. The device used to turn the workpiece (40) parallel to the direction of gripping is embodied in such a way that the arm (32, 32a) is rotated on its proximal end. The device for rotating the workpiece about its lateral axis (40) is embodied in such a way that the arm can rotate about itself.

The invention relates to a device for gripping and transporting workpieces in turning machines, for example in vertically arranged turning machines, as well as in milling and drilling machines for the workpiece and pallet transport.

For the economical use of turning machines for sequentially processing workpieces—optionally with different tools—in the past, different multiple-spindle machine tools have been proposed. Such a multiple-spindle turning machine is known from DE 195 04 369. Therein, the multiple-spindle turning machine comprises a machine frame, a spindle carrier pivotally arranged at the machine frame, multiple workpiece spindles disposed suspending from the spindle carrier. With such a multiple-spindle turning machine, a quite high processing capacity can be achieved. From the magazine Produktion, No. 8, February 1997, page 10, for example, a multiple-spindle turning machine having eight spindles is known.

However, multiple-spindle turning machines have fundamental disadvantages, which are to be overcome by the present invention. On the one hand, multiple-spindle turning machines are prone to failure, since the processing operations are performed closely adjacent and can influence each other. On the other hand, multiple-spindle turning machines are not very flexible in use. If e.g. an operation requires seven or even less processing partial operations, which all require approximately the same time expenditure, then a multiple-spindle turning machine having eight spindles can no longer be utilized efficiently. Further, the accessibility in case of service and repair is very severely restricted.

From DE 198 35 868, a device for processing workpieces is known, which makes executable plural different or partially also identical processing operations in sequence, but nevertheless has the required flexibility to avoid idling in a new processing operation. In spite of the capability of high throughput, the processing machine is easily accessible.

But, for such a multiple turning machine, the designer is confronted with the task to transport the workpieces between the individual processing devices. Fundamentally, the approach known from DE 198 36 868 is executable with rotation/swivel devices for transporting the workpieces between the individual processing units. However, it has turned out that it is the transporting operation between the rotating devices, which can still be improved, namely, the transporting operation of the workpieces should be more universal, particularly allow for multiple degrees of freedom.

Therein, for an advantageous design of an assembly of multiple turning machines, the transport and the supply of the workpieces is of substantial importance. In particular for the universal use, the assembly with a turning device for turning the workpieces replacing a turning machine can be disadvantageous, since in this case the turning operation always can only be performed at one location.

From EP-A-0 721 821, a handling device for a machine tool is known, which essentially has the features of the preamble of claim 1. This device is equipped with a lever drive, however complicating the rotation of the workpiece. Additionally, it has turned out that for handling heavy workpieces at high rotational speed, the use of a lever mechanism is inadequate. This disadvantage is to be overcome by the invention, too.

The object of the invention is achieved by a gripping and transporting device according to claim 1. Therein, the measures of the invention first result in the workpiece being able to be removed from the turning device, which preferably occurs downward. A preferred horizontal 180° swing transports the workpiece to the next turning device and inserts it by lifting. By the possibility of turning the workpiece about its lateral axis, it is possible to rotate the workpiece such that the previously top end is now oriented downward.

By the special measures of the invention, namely that a swivel arm, which is rotatable about itself and thereby, unlike a lever mechanism as known from EP-A-0 721821, can also quickly rotate heavy workpieces, has its pivot point at its proximal end, wherein the swivel arm additionally can be moved in one direction—namely substantially laterally and thereby so that the direction of a rod-shaped workpiece is substantially maintained—the stability of the movement—thus, the possibility of quickly moving heavy workpieces, preferably rod-shaped workpieces, in certain movement sequences—is facilitated. Preferably, swiveling occurs such that in case of rod-shaped workpiece, the direction of the rod is also maintained during the swing. Therein, it has to be emphasized that e.g. with respect to a lever mechanism such as known from EP-A-0 721 821, the freedom of movement is restricted in some manner, namely adapted to the intended movement sequences. But, instead the advantage of increasing the speed in case of heavier workpieces is obtained.

The gripping and transporting device obtains a special advantage, if it can cooperate with similar devices. Namely, in this case, it is possible to insert the workpiece removed from the turning machine into the same or the next turning machine in reversed orientation—i.e. turned—even if the workpiece is so short that it can be gripped by the transporting and gripping device only where the processing is to be started in the next processing operation. In this case, the first transporting and gripping device grips the workpiece exactly there and turns it 180° about the lateral axis as described above. Then, it is gripped by the second transporting and gripping device, the first transporting and gripping device is released, and the workpiece is inserted into the same or the next processing turning machine. Such gripping over is especially advantageous if the workpiece is short and is to be processed with two turning processing operations, the processing ranges of which succeed each other. It is understood that turning (rotation about the lateral axis) can not only be provided by the first, but alternatively also by the second transporting and gripping device.

For the gripping devices themselves, plural gripping mechanisms are possible, which are partially specially defined in the dependent claims.

The above mentioned as well as the claimed elements and the ones of the embodiment described below, which are to be used according to the invention, are not subjected to special exceptional conditions in their size, shape design and technical conception, so that the selection criteria known in the respective application field can be applied unlimited.

Further details, features and advantages of the object of the invention result from the following description of the accompanying drawing, wherein—by way of example—a transporting and gripping device according to the invention is illustrated.

The drawings show in

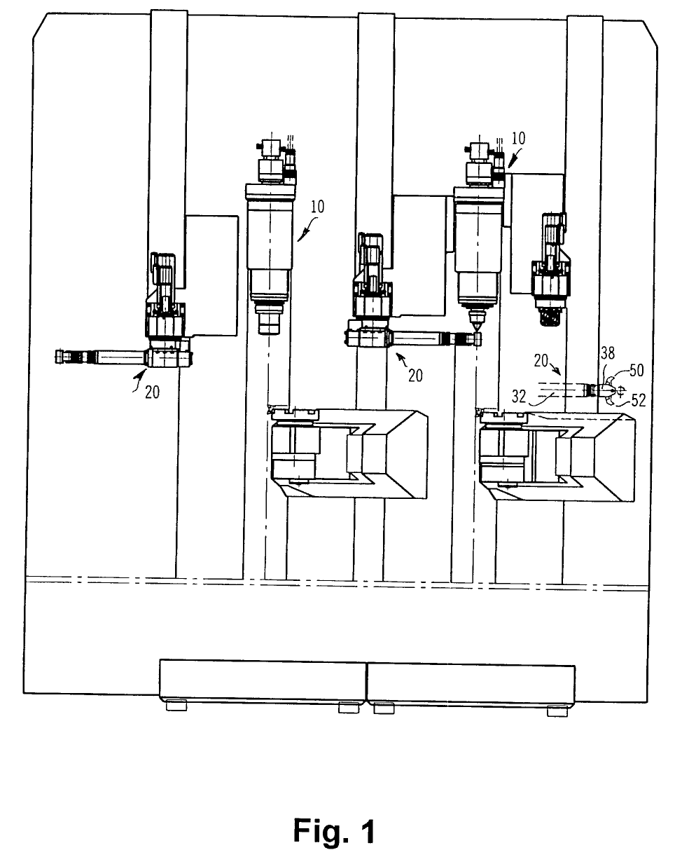

FIG. 1 a view of the multiple turning machine having a transporting and gripping device according to the invention from the front;

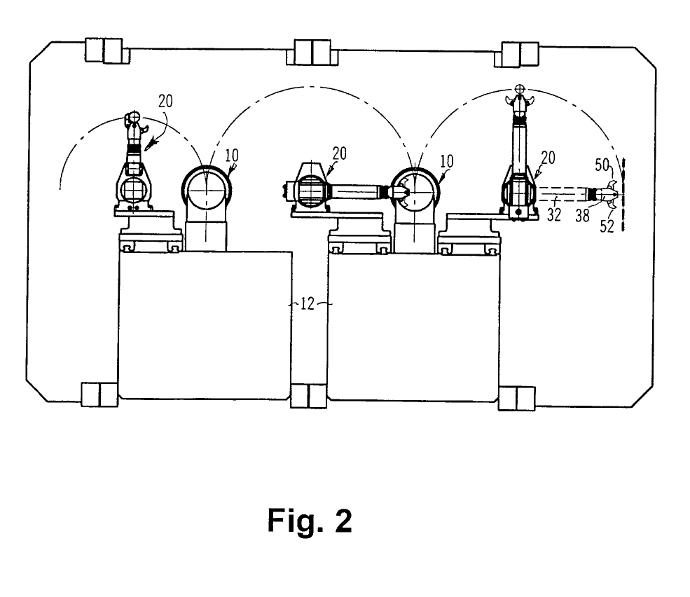

FIG. 2 the device of FIG. 1 from above;

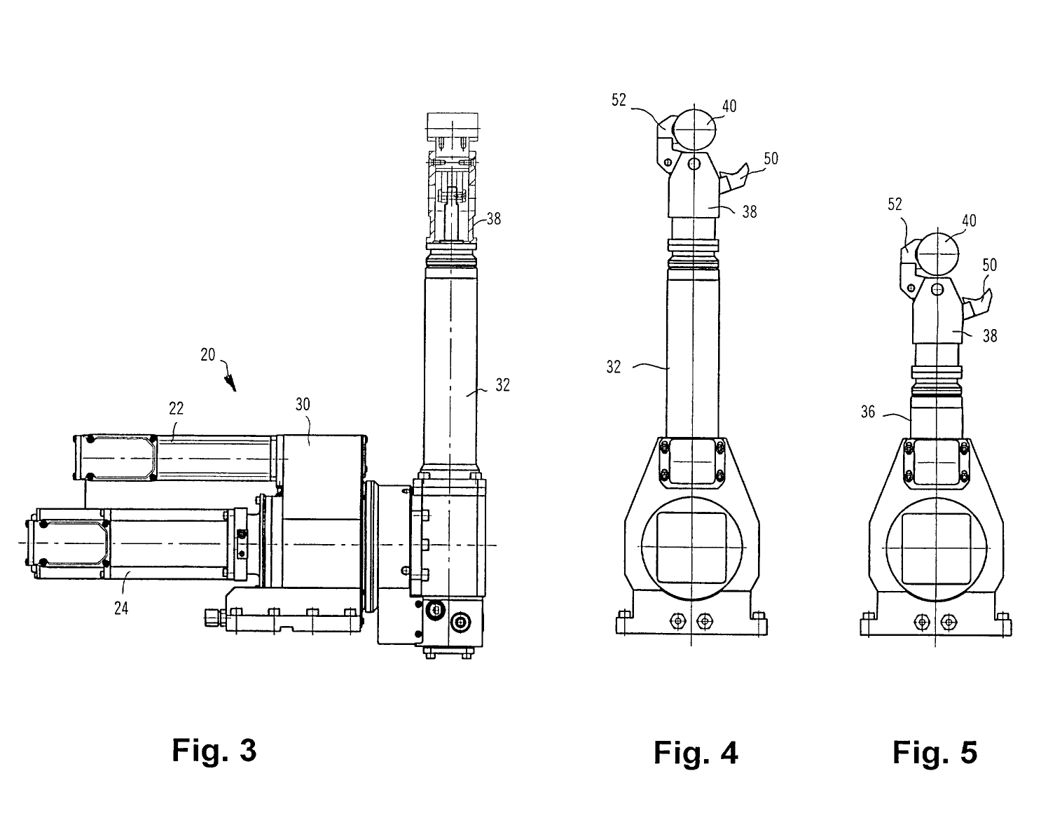

FIG. 3 a transporting and gripping device according to the invention with the associated drive from the side;

FIG. 4 the gripper of the device of FIG. 3 from the front;

FIG. 5 an alternative gripper with shorter arm from the front;

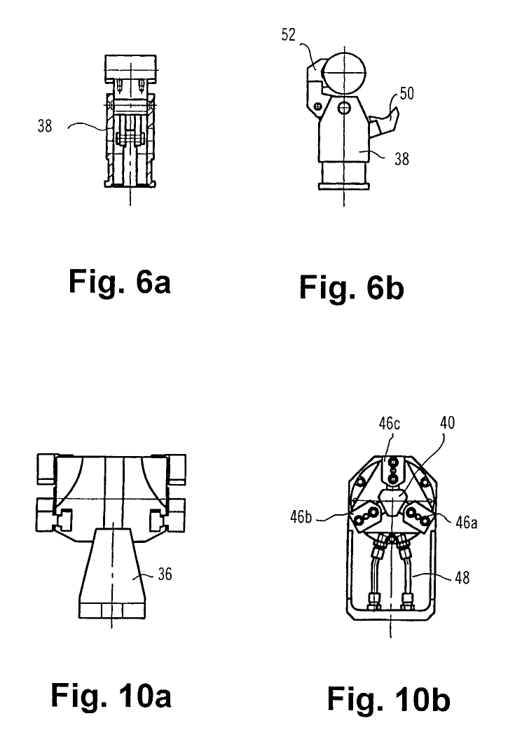

FIG. 6 the gripping head according to FIG. 4 and 5 from the side and from the front (6a and 6b);

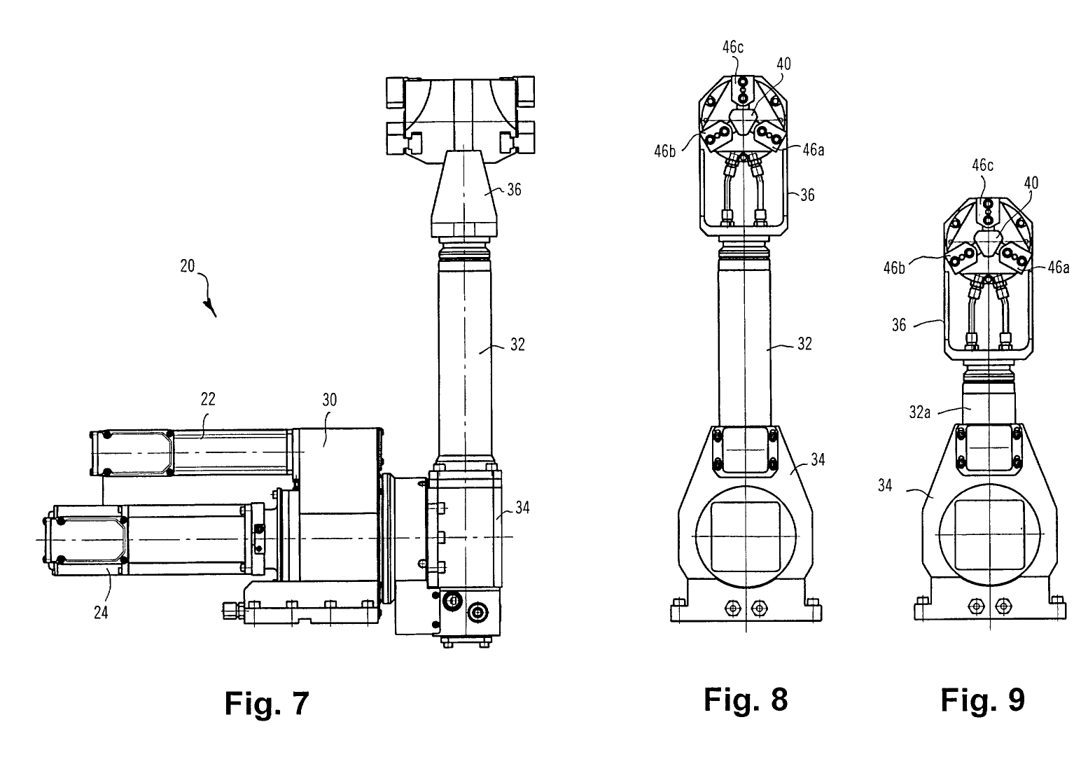

FIG. 7 the gripper of the device having gripping jaws from the side;

FIG. 8 the gripper of the device having gripping jaws from the front;

FIG. 9 an alternative gripper corresponding to FIG. 7 with gripping jaws and with shorter arm from the front;

FIG. 10 an alternative head for clamping the workpiece from the side and from the front (10a and 10b);

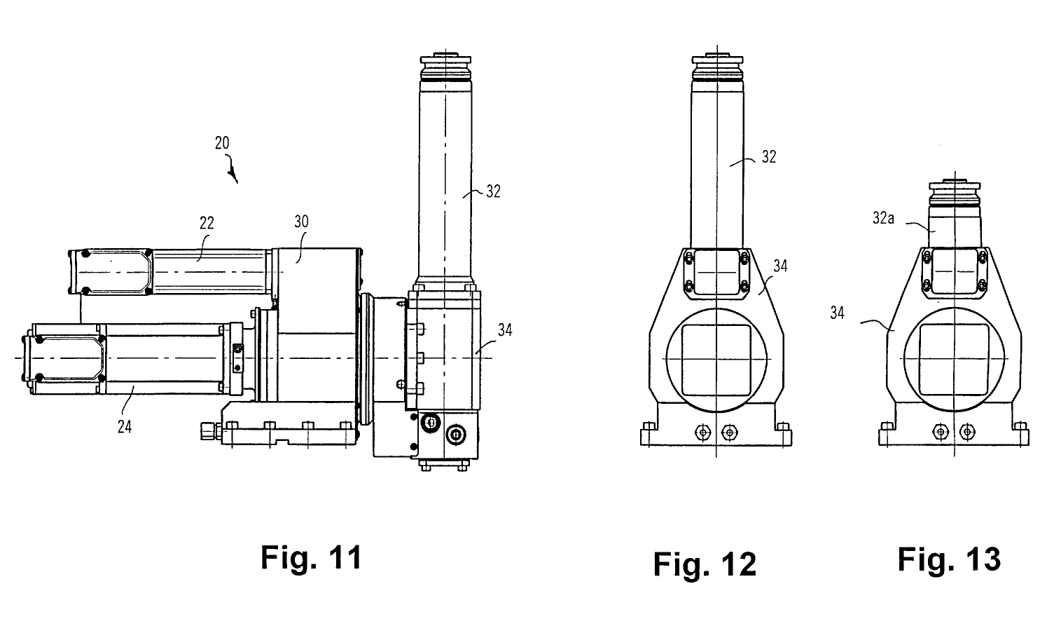

FIG. 11 the gripper of the device without gripping head from the side;

FIG. 12 the gripper according to FIG. 11 without gripping head from the front;

FIG. 13 the alternative gripper corresponding to FIG. 10 without gripping head, but with shorter arm;

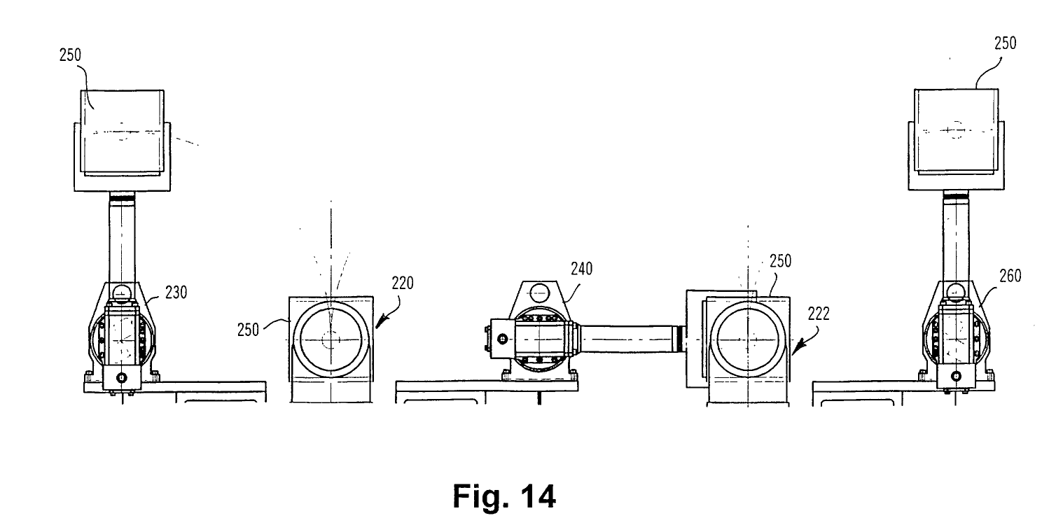

FIG. 14 an alternative use of the transporting and gripping device for use in a milling machine.

In FIG. 1, an assembly for the invention is shown from the front, wherein three transporting and gripping devices 20 serve two vertically positioned turning machines 10. Both the turning machines 10 and the transporting and gripping devices 20 are attached to mounting blocks 12. The workpieces 40 are supplied to the turning machines by the transporting and gripping devices by being swiveled beneath the clamping device of the turning machine and then being inserted into the clamping device by lifting the gripper arm 32. In the clamping device of the turning machines, the workpieces 40 are then clamped and processed in the conventional manner. During processing, the arm of the transporting and gripping device 20 is turned away from the turning machine in order not to interfere with the processing operation. After the end of the processing operation, then, in the simple application case, the gripping arm 32 of the next transporting and gripping device 20 is turned to the workpiece 40 and the workpiece is gripped by actuating the gripping tongs 50 and 52. Therein, the gripping arm has been brought into the correct height by actuating the height adjustment. By swiveling the gripping arm 32, the workpiece 40 is then swung to the next turning machine, or—in case of the last processing operation—to further storage or other provision. Therein, the workpiece can also be rotated 180° about its lateral axis by rotation of the gripping arm 32 about itself, if e.g. the other side of the workpiece 40, at which it has been clamped before, is to be processed.

In a special processing operation, turning can also be done by additional gripping over. Therein, first, the gripping arm of one of the two transporting and gripping devices 20 grips the workpiece 40 after its processing and discharges it as described above. Thereupon, the workpiece 40 is rotated 180° about its lateral axis, so that the previously top portion now is at the bottom. The gripping arm 32 of the second transporting and gripping device 20 now grips the workpiece 40 in its now lower portion, whereupon the gripping arm 32 of the first transporting and gripping device 20 releases the workpiece 40. The second transporting and gripping device 20 now inserts the workpiece 40 into the turning machine 10 or—after a transporting operation by turning its gripping arm 32—into the next turning machine 10, where the workpiece 40 can then be processed in the other end. It is understood that the rotation of the workpiece about its lateral axis can also be performed by the gripping arm 32 of the second transporting and gripping device 20. The special processing operation described here has advantages if the workpiece is short and can be and has to be completely processed in two processing operations each relating to one portion of the workpiece.

The transporting and gripping devices 20 are illustrated in detail in FIGS. 3 and 4. The central block 30 of the transporting and gripping devices 20 includes a gear driven by the drive 22. By the driving device 22, the gripping arm 32 can be rotated about itself. By the second driving device 24, the gripping arm 32 can be swung about its radial supporting point 34 at its proximal end. Additionally, the multiple processing machine of the present design has a linear drive, by which the gripping arm 32 as a whole can be moved from and to the block 30 in a linear movement for enabling the above described lifting and lowering operations of the workpiece 40. In the embodiment, the gripping operation itself is driven hydraulically, thereby closing or opening the gripping pliers 50 and 52.

The gripping tongs 50 and 52 are arranged such that, in case of opened tongs, they release the workpiece so much that they do not interfere with it when swiveling the gripping arm, in the embodiment, an opening angle of over 180° is achieved. The gripping tongs themselves have a contour such that both gripping tongs respectively grip the workpiece at two points or lines of engagement, respectively. In the embodiment, provision is made that in case of substantially different workpiece thicknesses, the gripping heads 38 are exchanged. This is allowed by the gripping heads being able to be attached modularly to the gripping arms as can be seen from FIGS. 11 to 13.

In FIG. 5, the gripping arm 32a of a transporting and gripping device with shortened gripping arm is illustrated.

In FIGS. 7 to 9, a transporting and gripping device is shown, wherein—corresponding to the modular concept—an alternative gripping head having three or six gripping jaws 46a, 46b and 46c, respectively, is shown. These gripping jaws are put over the workpiece 40 by the lifting operation already described above in the opened state, and closed by radially closing the jaws, thereby retaining the workpiece 40. This alternative concept with the gripping jaws, which are additionally illustrated individually in FIGS. 10a and 10b, has advantages especially if the workpiece is not round along its length, but has a special contour, such that special points of engagement have to be selected, and gripping tongs are not so well suitable. In FIG. 10b, the hydraulic or pneumatic supply lines 48, respectively, are shown, which are connected to the gripping arm.

In the assembly, in which the invention is used by way of example, plural turning machines each having a vertical rotational axis are contained. Each one of these turning machines has a main spindle for receiving the workpiece. In the embodiment, this main spindle is respectively attached at the top. The individual turning machines are additionally equipped with a roller V-rest for lateral support of the workpiece during the rotational processing, and with another spindle (synchronous spindle) rotating synchronously with the main spindle and attached at the bottom.

At each turning machine, in the front, right region in the embodiment, a turret-like providing device for various processing tools is provided. It is advantageous to dispose this device at an angle of about 45° laterally in front of the turning machine.

In front of the first turning machine, a cutting device for elongated work material is provided. The work material is supplied from a conveying means, and after cutting it is supplied by a transporting and gripping device of the first turning machine disposed in front of the first turning machine.

Behind the last turning machine, an additional transporting and gripping device for further handling of the processed workpiece is provided.

The assembly as a whole is accommodated in a housing closed upward and to the sides. Thus, this housing allows the turning machines to be accessible from the front. However, it can be provided that the housing can also be closed to the front.

Additionally, in the embodiment, the turning machines are provided with a cover to the front at the level of the processing operation, in order to ensure the required working protection.

In FIG. 14, another application of the transporting and gripping device according to the present invention is illustrated. The use according to FIG. 14 is a multiple milling machine, wherein the workpieces are supplied on a square pallet and processed. In the embodiment of this alternative application, this multiple milling machine is equipped with two milling stations, which process the workpieces at the positions 220 and 222. The workpieces are supplied on a square pallet 250 by a first gripping and transporting device 230. After the first processing operation, a second gripping and transporting device 240 transports the pallet 250 with the workpiece on to the second milling position 222. After the second milling operation, the pallet 250 is then transported away by means of a third gripping and transporting device.

By way of the last example, it becomes clear to one skilled in the art, that the use of the gripping and transporting device according to the present invention can also be extended to combinations of turning, milling or drilling machines having multiple stations, so that the invention can experience a wide spectrum of use in the scope of the following claims.

1. Transporting and gripping device for transporting workpieces, particularly substantially rod-shaped workpieces, to and from a processing device, comprising
a gripping mechanism (38; 50, 52; 46a, 46b, 46c) for gripping the workpiece (40), particularly for gripping along the rod,
a device (24) for moving the workpiece substantially in the longitudinal direction of the workpiece (40) by displacing the transporting and gripping device,
a device for swiveling (22, 30) the workpiece (40), particularly by maintaining the direction of gripping,
a device for rotating the workpiece (40) substantially about the lateral axis of the workpiece (40),
wherein the device has an arm (32, 32a), to the distal end of which the gripping device (38; 50, 52; 46a, 46b, 46c) is attached,
characterized in that
the device (24) for swiveling the workpiece (40), particularly by maintaining the direction of gripping, is formed by rotating the arm (32, 32a) about a base point at its proximal end, and
the device (22, 30) for rotating the workpiece substantially about the lateral axis of the workpiece (40) is formed such that the arm (32, 32a) can be rotated along itself.

2. Transporting and gripping device according to claim 1, characterized in that the gripping device includes two gripping tongs (50, 52) with a contour for specifying the retaining points of the workpiece (40).

3. Transporting and gripping device according to claim 2, characterized in that the gripping tongs (50, 52) enable such a wide opening angle that the workpiece (40) can be moved laterally with opened gripping tongs (50, 52).

4. Transporting and gripping device according to claim 1, characterized in that the gripping device includes at least three retaining jaws (46a, 46b, 46c), which are moved radially for opening, and wherein the workpiece (40) is inserted orthogonally to the retaining jaws (46a, 46b, 46c), before the retaining jaws (46a, 46b, 46c) are moved radially towards the workpiece (40) to retain it.

5. Device for processing workpieces including at least two of turning machines (10) disposed side-by-side, each having a rotationally driven main spindle installed vertically, for clamping the workpiece, and at least one device for receiving multiple processing tools, wherein the rotational axes of all of the turning machines (10) are disposed substantially vertically, and between the turning machines (10) a transporting and gripping device according to any one of claims 1 to 4 is provided, by which the workpiece can be passed from one of the turning machines to the next turning machine by swiveling horizontally after processing.

6. Device according to claim 5, characterized in that a first transporting and gripping device (10) is provided, by which the workpiece can be supplied to the first turning machine as a blank from a supply device.

7. Method for transporting a workpiece (40) in a multiple turning machine according to claim 5 or 6, characterized in that, first, the gripping arm (32, 32a) of one of two transporting and gripping devices 20 having access to the workpiece (40) in the respective turning machine, discharges the workpiece (40) after a first processing, thereupon turns the workpiece (40) 180° about its lateral axis, such that the previously top portion is at the bottom, the gripping arm (32, 32a) of the second transporting and gripping device (20) grips the workpiece (40) in its now bottom portion, and the second transporting and gripping device (20) now inserts the workpiece (40) into the turning machine (10), or after a transporting operation, into the next turning machine (10) by swiveling its gripping arm (32, 32a).

8. Device for processing workpieces including at least two of milling machines (220, 222), wherein between the milling machines (220, 222) a transporting and gripping device according to any one of claims 1 to 4 is provided, by which the workpiece can be passed from one of the milling machines to the next milling machine by turning after processing.

9. Method for transporting a workpiece (40) in a multiple milling machine according to claim 8, characterized in that workpieces are disposed on a pallet (250) the transporting and gripping devices (220, 222), and the transporting and gripping devices (220, 222) grip the pallet (250) and transport the workpiece on the pallet (250).
